(19) United States
(12) Patent Application Publication
(10) Pub. No.: US 2006/0266198 A1
(43) Pub. Date: Nov. 30, 2006

(54) Snare drum accessory

(76) Inventors: Walter B. Jeffries, Cloverdale, OR (US); Tyler D. Hauth, Cloverdale, OR (US)

Correspondence Address: GENE W. ARANT, P.O. BOX 269, LINCOLN CITY, OR, 97367-0269, US

(21) Appl. No.: 11/398,894

(22) Filed: Apr. 7, 2006

Related U.S. Application Data
(60) Provisional application No. 60/685,333, filed on May 26, 2005.

(51) Int. Cl. G10D 13/02

(52) U.S. Cl. 84/417

(57) ABSTRACT

An adjustment mechanism for selectively tightening the snare wires of a snare drum, having a camming mechanism cooperatively formed by two concentric members with an inherent level of friction that allows it to be reliably set at either extreme position of adjustment of the tightness of the snare wires or at any desired intermediate position of adjustment, thus allowing the musician a full range of choice of the musical tones or effects to be produced by the snare wires.

### PRIORITY CLAIM

This application claims the priority of our provisional application Ser. No. 60/685,333 filed May 26, 2005.

### FIELD OF THE INVENTION

This invention relates to the field of musical instruments, and particularly snare drums.

### BACKGROUND OF THE INVENTION

A typical snare drum has a cylindrical shell with drumheads of flat circular configuration mounted on both its top and bottom ends. Each drumhead is surrounded by a circumferential rim. A group of snare wires extend beneath and across the lower drumhead, in a normally loose configuration. A mechanism which allows the musician to tighten the snare wires causes them to impact the bottom surface of the lower drumhead, generating sounds of a distinctive character, since the vibratory motions of the bottom drumhead are then modified by contact with the snare wires.

In the presently standard snare drum, at one of their ends the snare wires are supported in abutting relationship to the associated circumferential rim of the bottom drumhead by means of a butt plate and associated clamps which hold the butt plate in rigidly attached relationship to the drum shell. At their other ends the snare wires are attached to a T bracket, which holds them snubbed up against the circumferential bottom rim of the drum. By selectively moving the T bracket up or down the musician selectively tightens or loosens the snare wires to produce a desired musical effect.

In presently standard snare drums the T bracket is movable between two extreme positions, but the control mechanism is not continuously adjustable to allow the free selection of any intermediate condition of tightness of the wires. The musician must therefore be satisfied with an available position of adjustment and whatever musical sounds the wires then create.

### SUMMARY OF THE INVENTION

According to the present invention we control the selective tightening of the snare wires by a camming mechanism that has an inherent level of friction which allows it to be reliably set at an extreme upper position of adjustment of the T bracket, at an extreme lower position, or any desired intermediate position of adjustment. This provides the musician a full range of choice of the musical tones or effects to be created by the snare wires.

According to the presently preferred form of the invention a vertically extending drive cylinder is supported for free rotation but with its vertical movement inhibited, and an elongated lifting rod is disposed concentrically within the drive cylinder and supported for vertical sliding movement but with its rotational movement inhibited. The drive cylinder has a pair of circumferentially extending sloping grooves on its inner wall surface which are open towards the lifting rod, and a pair of dowel pins carried on opposing sides of the lifting rod slidingly engage the respectively corresponding grooves of the drive cylinder. Each of the grooves extends at least about half the circumference of the drive cylinder and slopes gently throughout its length so that the static friction of the dowel pins resting upon the grooves is sufficient to reliably maintain any rotational position of adjustment of the drive cylinder.

Further in accordance with the invention a housing member attached to the drum shell supports both the drive cylinder and the lifting rod in their operative positions.

### DRAWING SUMMARY

FIG. 1 is a pictorial representation of a snare drum in which the snare wires, T bracket, and butt plate are shown spaced away from the drum itself;

FIG. 2 is an exploded perspective view of interior parts of the mechanism of the presently preferred embodiment of our invention;

FIGS. 3(a) and 3(b) are schematic diagrams which illustrate the friction forces involved in a camming mechanism utilized in accordance with the invention;

FIG. 4 includes both an elevation view of the presently form of the mechanism, and a cross-sectional view of same; and

FIG. 5 is another elevation view of the presently form of the mechanism, taken at an angle of ninety degrees relative to the elevation view shown in FIG. 4, and with an accompanying cross-sectional view.

### DETAILED DESCRIPTION

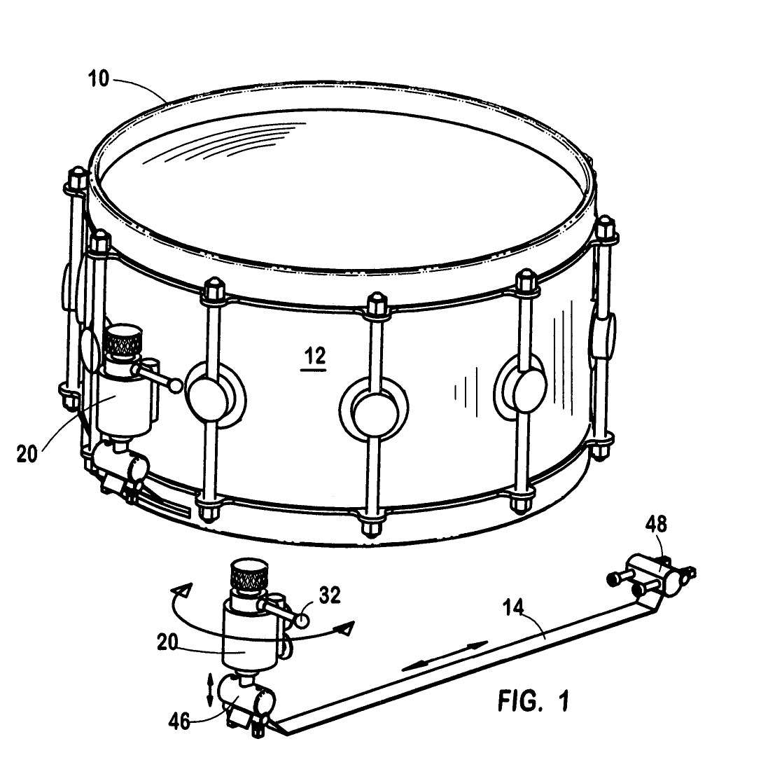

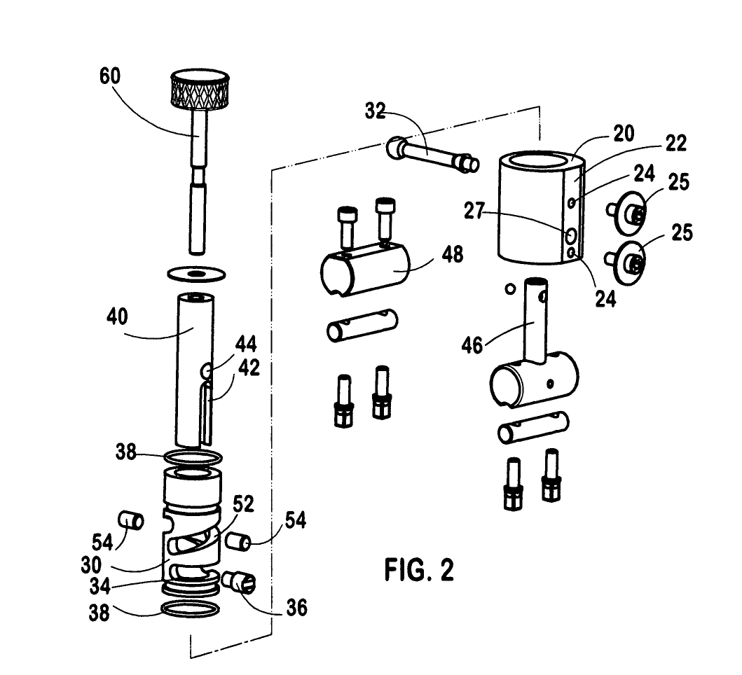

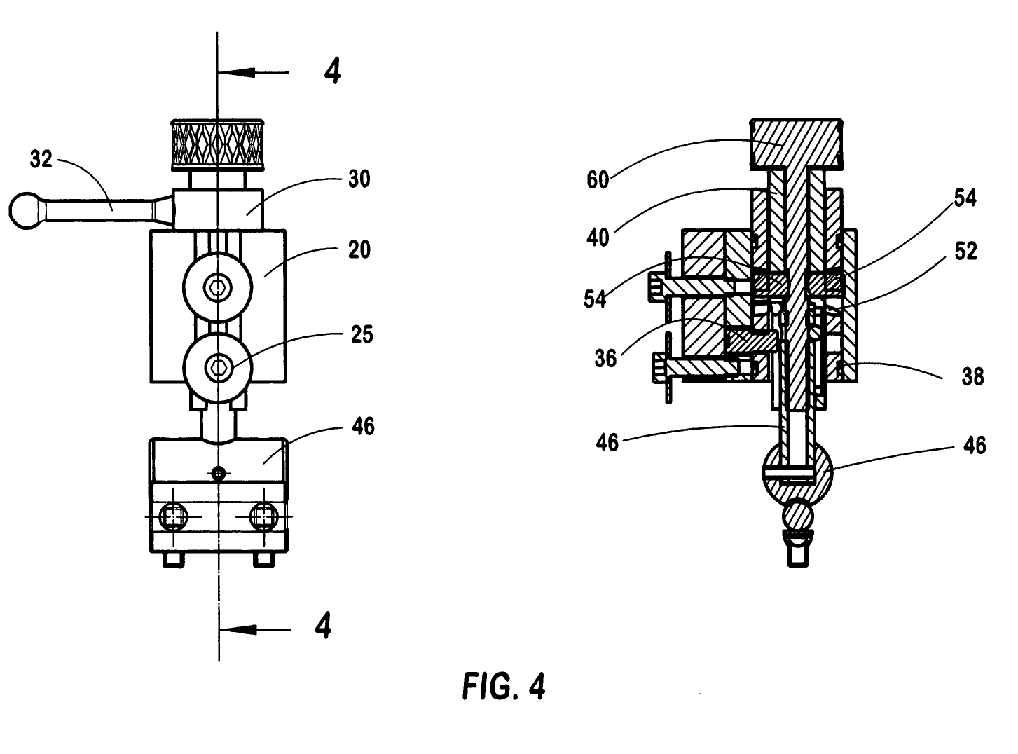

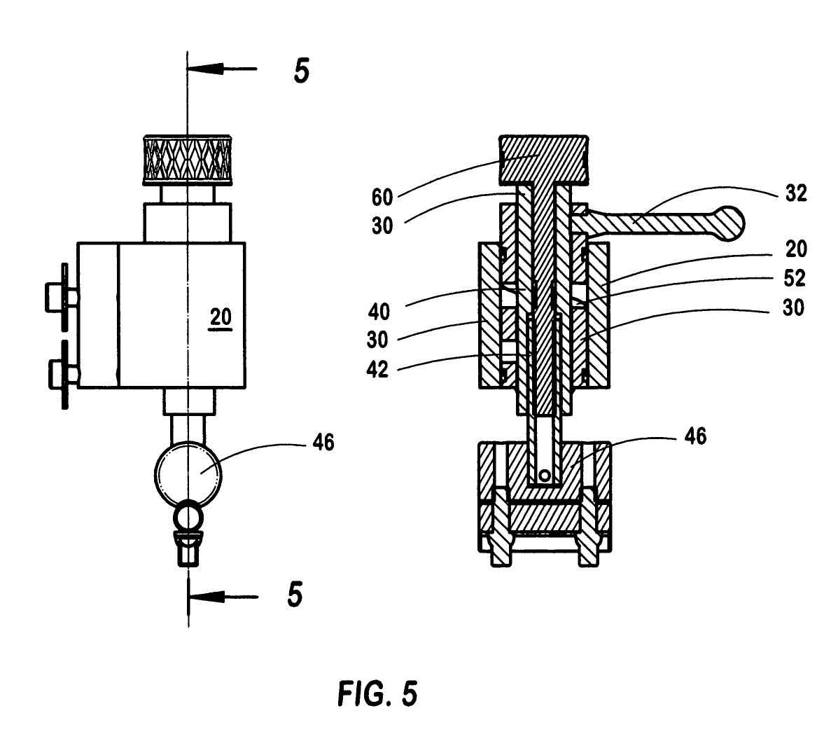

### (FIGS. 1-5, inclusive)

More particularly, according to the presently preferred form of our invention a snare drum 10 has a control housing 20 attached to an outer surface of the drum shell 12 which contains a drive cylinder 30 that extends vertically and is rotatable relative to the housing. Inside the drive cylinder 30 there is a vertically extending lifting rod 40 that is vertically movable within the drive cylinder but does not rotate relative to either the control housing or the drive cylinder. The lower end of the lifting rod 40 is secured to one end of the snare wires 14, for selectively tightening them when the lifting rod is lifted up.

A hand-operated camming mechanism is cooperatively formed by the drive cylinder and the lifting rod for selectively raising or lowering the lifting rod within the drive cylinder. The camming mechanism has an inherent level of friction which allows it to reliably set the lifting rod at either an extreme upper position of adjustment, at an extreme lower position, or at any desired intermediate vertical position of adjustment.

SNARE DRUM. As seen in FIG. 1, the snare drum 10 has a shell 12 and snare wires 14 which extend underneath the bottom drumhead, not specifically shown. A T bracket 46 is connected to one end of the snare wires and a butt plate 48 to their other end, as shown in FIG. 1. The preferred mechanism of the present invention has a drive cylinder 30 with a radially extending lever or handle 32 attached to its upper end, as shown only in FIGS. 1, 2, 4, and 5.

CONTROL HOUSING. The control housing 20 has a mounting surface 22 for attaching it to the outer vertical surface of drum shell 12. Threaded holes 24 are provided for a pair of attachment screws 25 which fixedly secure housing 20 to the drum shell. A threaded hole 27 is also provided near the lower end of mounting surface 22 to receive an assembly screw 36, which is therefore in a fixed relation to the control housing 20. The function of assembly screw 36 is later described in more detail.

DRIVE CYLINDER. Drive cylinder 30 is concentrically located inside housing 20 and also concentrically surrounds the lifting rod 40. Upper and lower O-rings 38 support the drive cylinder 30 within the housing 20. The lever or handle 32 attached to the drive cylinder upper end permits the musician to selectively rotate the drive cylinder 30 relative to both control housing 20 and lifting rod 40.

LIFTING ROD. The lifting rod 40 inside control housing 20 has a vertical slot 42 to receive the inner end of assembly screw 36. Assembly screw 36 extends into the slot 42, as further described below. This allows the lifting rod 40 to move vertically relative to control housing 20 and drive cylinder 30 but without rotating relative to either of them.

ASSEMBLY SCREW. Threaded hole 27 near the lower end of mounting surface 22 of control housing 20 receives the assembly screw 36, which is therefore held in fixed relation to the control housing 20. In the lower end of drive cylinder 30 a horizontal slot 34 is provided to receive the assembly screw 36. Horizontal slot 34 in conjunction with assembly screw 36 therefore maintains a fixed vertical position of the drive cylinder 30 relative to the control housing 20. The assembly screw 36 extends not only through that horizontal slot 34 but also into the vertical slot 42 in the lifting rod 40. This allows rotation of the lever 32 on the drive cylinder upper end to raise or lower the lifting rod 40, and hence to tighten or loosen the snare wires 14, without rotating the lifting rod itself.

DETAIL OF LIFTING ROD. Lifting rod 40 is located concentrically within drive cylinder 30 and hence within control housing 20. Its vertical slot 42 receives the assembly screw 36 in a vertical sliding relationship, allowing an up or down movement of the lifting rod when the tightness of the snare wires is being adjusted. A pair of alignment holes or pin holes 44 are provided in opposing side walls of the lifting rod 40, which receive the inner ends of respective ones of a pair of lifting pins or dowels 54. The outer ends of dowels or lifting pins 54 engage respective sloping grooves 52, for lifting or lowering the lifting rod in response to rotation of the drive cylinder relative to control housing 20, as will be further described in detail. T bracket 46 is attached, but somewhat indirectly, to the bottom end of lifting rod 40, to be raised or lowered so as to tighten or loosen the snare wires 14.

Thus according to the presently preferred form of the invention a generally cylindrical housing 20 is attached in a fixed position to an outer surface of the drum shell 12. An elongated drive cylinder 30 is located inside the housing 20 with its longitudinal axis extending vertically, and is rotatable relative to the housing. The drive cylinder 30 is hollow, and a vertically extending lifting rod 40 is vertically movable within the drive cylinder. Horizontal slot 34 in drive cylinder 30 in conjunction with the assembly screw 36 maintains a fixed vertical position of the drive cylinder 30 relative to the control housing 20 when the drive cylinder is rotated. The lower end of lifting rod 40 is secured to T bracket 46 which in turn is secured to one of the ends of the snare wires 14 for controlling their tension.

CAMMING MECHANISM. A camming mechanism is provided by the cooperative action of the dowels or lifting pins 54, whose inner ends engage the pin holes 44 in the lifting rod 40 while their outer ends are supported upon the pair of sloping grooves 52 in drive cylinder 30. The sloping slots or grooves 52 formed in the wall of drive cylinder 30 are inclined uniformly throughout their length to permit complete operator selection of the tightness or looseness of snare wires 14. The outer end of lever or handle 32 provides for operator rotation of the drive cylinder 30 and hence control of tightness of the snare wires. The lifting pins or dowels are removable, and a careful assembly procedure is therefore needed in order to put all portions of the entire mechanism including the lifting pins 54 into proper operative positions.

Thus the camming mechanism operates in cooperation with both the drive cylinder 30 and lifting rod 40 for selectively raising or lowering the lifting rod to tighten or loosen the snare wires. It is very important that each of the sloping grooves 54 extends for at least approximately half the circumference of the drive cylinder 30. In similar fashion, the horizontal slot 34 in the lowermost end of drive cylinder 30 permits the drive cylinder 30 to rotate by at least about 180 degrees relative to the lifting rod 40. Since the drive cylinder 30 is of larger diameter than the lifting rod 40, the outer ends of the lifting pins 54 move by a very substantial distance along the length of the respective sloping grooves 52. It is this rather large distance that makes it possible to have a rather gentle slope of the grooves or cam surfaces 52, which in turn makes it possible to have a rather high degree of static friction between the lifting pins or dowels 54 and the lower surfaces of grooves 52.

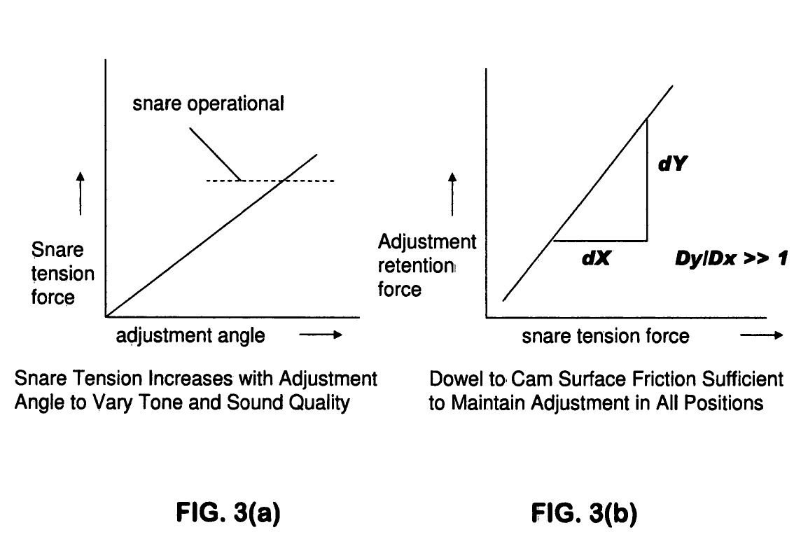

FIGS. 3(a) and 3(b) illustrate how the static friction of the camming mechanism serves to hold the snare wires in their selected condition of tightness. FIG. 3(a) shows that as the rotatable angle of adjustment varies, the snare wire tension to vary the tone and sound quality also varies as a function of the adjustment angle,

FIG. 3(b) diagrammatically illustrates that because of the slope of the sloping grooves 52, and the static frictional force of the outer ends of dowel pins 54 resting upon cam surfaces 52, the force of the static friction always exceeds gravitational force that would tend to make the dowel pins slide downward along the surfaces of the respective sloping grooves 52. In FIG. 3 (b) the rate of change of the frictional retaining force is represented as dY, while the gravitational force is represented as dX. Thus, the value of dY always exceeds the value of dX. That relationship is still true when the lifting rod is lifted up and the tension of the snare wires adds to the downward force on dowel pins 54.

### OPTIONAL FEATURE

FINE TUNING ADJUSTMENT. In the presently preferred form of the invention the knob head of fine tuning rod 60 always rests upon the top end of the lifting rod 40. The lower end of rod 60 is threaded (not specifically shown in the drawings) and engages internal threads inside the T bracket 46 (also not shown), thus providing a fine adjustment of the initial or quiescent elevation at which the T bracket is supported relative to the lifting rod. Thus the T bracket 46 is not attached directly to the bottom end of lifting rod 30, but instead its starting position is established through the fine tuning rod 60. Inclusion of that fine tuning mechanism, however, is an optional feature of the invention, as the lower end of lifting rod 40 may instead be attached directly to the T bracket 46, if a fine tuning adjustment is not being used.

While a particular embodiment of the invention has been disclosed in detail in order to comply with requirements of the patent laws, it will be understood that the scope of the invention is to be determined only in accordance with the appended claims.

### PARTS LIST

10 Snare drum
12 shell
14 snare wires
axis of drum shell (no number)
bottom of drumhead (not shown)
20 control housing
22 the mounting surface of control housing 20
24 two threaded holes in 20 for attachment screws
25 two attachment screws
27 threaded hole in 20 for assembly screw 36
30 drive cylinder (inside housing 20 and surrounding rod 40)
32 lever or handle to rotate drive cylinder relative to 20 and 30 (shown in FIGS. 1, 2, 4, and 5, only).
34 horizontal slot in bottom end of drive cylinder 30 (for assembly screw 36)
36 assembly screw
38 upper and lower O-rings supporting 40
40 lifting rod (inside drive cylinder 30)
42 vertical slot in lifting rod receiving assembly screw 36
44 alignment holes (pin holes) in lifting rod wall receiving dowels 54 to support and lift the lifting rod in response to rotation of the drive cylinder 30

46 T bracket attached (indirectly) to bottom of rod 30 through rod 60, to raise or lower clamp, to tighten or loosen the snare wires 14. (threaded lower end of 60 engaging threads inside T bracket 46 is not shown)
48 butt plate clamped at remote end of snare wires 14.
camming mechanism has no separate number
52 two sloping grooves in drive cylinder 30 wall
54 lifting pins (dowel pins)
60 Fine tuning rod (its head rides on top of 40).

What we claim is:

1. An adjustable strainer for adjusting the tension of snare wires in a snare drum, comprising:
a) a vertically extending drive cylinder supported for free rotation but with its vertical movement inhibited;
b) an elongated lifting rod disposed concentrically within the drive cylinder and supported for vertical sliding movement but with its rotational movement inhibited;
c) the drive cylinder having a pair of circumferentially extending sloping grooves on its inner wall surface which are open towards the lifting rod;
d) a pair of dowel pins carried on opposing sides of the lifting rod and slidingly engaging corresponding grooves of the drive cylinder;
e) the lifting rod having its lower end secured to an end of the snare wires for controlling their tension;
f) a handle attached to and extending horizontally from the drive cylinder for selectively rotating the drive cylinder to thereby tighten or loosen the snare wires; and
g) each of the grooves extending at least about half the circumference of the drive cylinder and sloping gently throughout their length so that the static friction between the, dowel pins and grooves is sufficient to reliably maintain the position of the drive cylinder in any rotational position of adjustment.

2. An adjustable strainer as in claim 1 which further includes a control housing concentrically surrounding the drive cylinder, and an assembly screw carried by the control housing for inhibiting both vertical movement of the drive cylinder and rotational movement of the lift rod.

3. In an adjustable strainer for a snare drum, an adjustment mechanism that has relatively rotatable inner and outer concentric members, a pair of sloping grooves extending for at least approximately half the circumference of the outer concentric member, and a pair of dowels having inner ends supporting the inner concentric member and with their outer ends engaging respective sloping grooves, the static frictional force at any position of rotational adjustment between the outer ends of the dowel pins and the surfaces of the respective sloping grooves always exceeding the gravitational force that would tend to make the dowel pins slide downward along the grooves.

4. An adjustable strainer as in claim 3 which further includes a housing member supporting both of the inner and outer concentric members in their operative positions.

5. In a snare drum having a drum body with a lower drumhead of flat configuration mounted on its bottom end, an improved snare wire control comprising:
a group of snare wires extending beneath the lower drumhead;
a control housing fixedly secured to an outer surface of the drum body adjacent one end of the snare wires;
a drive cylinder in a fixed vertical position within the housing but rotatable relative thereto;
a lifting rod extending vertically within the drive cylinder and vertically movable relative to both the housing and the drive cylinder, but non-rotatable relative to the housing, the lower end of the lifting rod being secured to one end of the snare wires to selectively tighten them whenever the lifting rod is lifted;
a hand lever secured to the upper end of the drive cylinder for selectively rotating the drive cylinder relative to the housing; and
a camming mechanism responsive to rotation of the hand lever for raising or lowering the lifting rod within the drive cylinder, the camming mechanism including a pair of circumferential grooves in the inner wall of the drive cylinder which are uniformly sloped throughout their length, and a mating pair of dowel pins carried by the lifting rod;
the inherent level of friction between the dowel pins and the lower surfaces of the grooves being sufficient to reliably maintain the lifting rod at either vertical position of extreme adjustment or at any desired intermediate vertical position of adjustment.

6. A snare drum accessory as in claim 5 wherein the drive cylinder is rotatable for at least about half a rotation relative to the housing.

7. A snare drum accessory as in claim 5 wherein one end portion of the lifting rod has a vertical slot formed therein, and which further includes an assembly screw secured to the control housing wall and extending radially inwardly therefrom and through a circumferentially extending horizontal slot in the drive cylinder wall and engaging the vertical slot in the lifting rod to prevent it from rotating relative to the housing.

8. A snare drum accessory as in claim 7 wherein the drive cylinder is rotatable for at least about half a rotation relative to the housing.
